(19) United States
(12) Patent Application Publication
(10) Pub. No.: US 2020/0325426 A1
(43) Pub. Date: Oct. 15, 2020

(54) Apparatus And Method For Accelerating The Maturation Of Bourbon Whiskey Using Cyclic Motion

(71) Applicant: Bradford Botner, Shelbyville, KY (US)

(72) Inventor: Bradford Botner, Shelbyville, KY (US)

(21) Appl. No.: 16/844,620

(22) Filed: Apr. 9, 2020

Related U.S. Application Data
(60) Provisional application No. 62/833,226, filed on Apr. 12, 2019.

(51) Int. Cl. C12H 1/22; B63B 35/44; B65G 1/02; B65G 69/28; B63B 75/00; B65D 71/00

(52) U.S. Cl. CPC C12H 1/22; B63B 35/44; B65G 1/02; B63B 2035/4486; B63B 75/00; B65D 71/0088; B65G 69/28

(57) ABSTRACT

An aging apparatus and method for accelerating the maturation of bourbon whiskey distilled spirit having characteristics associated with a much longer maturation process is provided. The method of accelerating the maturation of distilled spirits includes providing a storage warehouse secured in a waterway that produces waves and the storage warehouse has an enclosed interior. The method includes storing a plurality of barrels in the enclosed interior of the storage warehouse with the barrels being filled with distilled spirits. The method also includes moving the storage warehouse and the barrels therein by the waves of the waterway so as to circulate the distilled spirits within the plurality of barrels to thereby accelerate the maturation of the distilled spirits. The aging apparatus includes a base structure and a storage warehouse atop and secured to the base structure. The storage warehouse is sized to accommodate barrels filled with distilled spirts.

### CROSS-REFERENCE TO RELATED APPLICATIONS

This application claims the benefit of priority to U.S. Provisional Patent Application Ser. No. 62/833,226 filed Apr. 12, 2019 (pending), the disclosure of which is incorporated by reference herein.

### TECHNICAL FIELD

The invention relates generally to apparatus and methods for aging distilled spirits, and specifically, apparatus and method for accelerating the aging of distilled spirits.

### BACKGROUND

Traditionally, whiskey is made by aging high-proof distillate in an oak barrel. The distillate interacts with the oak barrel and thereby adds color, smoothness, flavor, and other favorable characteristics to the distillate as it sits in the barrel. The distillate may be aged anywhere from 2 to 50 years. Typically, the longer the distillate sits in the oak barrel, the more refined the color, smoothness, flavor, taste, and finish becomes.

While extended aging or maturation provides benefits to the overall whiskey product, there are disadvantages to such extended maturation. First, it costs producers more money to house the whiskey in the oak barrels over a longer period of time because they are not able to sell the whiskey to the consumers while it is maturing. In other words, maturing a whiskey for 5 to 10 years means the producer does not get any return on the investment in making the whiskey for 5 to 10 years.

Second, the producer must build and maintain large warehouses to store the thousands of oak barrels of whiskey being aged at any given time. Third, the whiskey evaporates through the oak barrels as it is being aged. According to some estimates, over 15% of the whiskey volume in a standard oak barrel evaporates in the first four years of aging. The evaporated share of the whiskey is often referred to as the Angel's Share. Thus, as the whiskey is aged longer and longer, less of the whiskey is available for sale to consumers.

Whiskey producers have tried various methods to accelerate the aging process, while still achieving the same benefits (e.g., refined color, smoothness, flavor, etc.) of extended maturation. For example, whiskey producers have used pressure, wood chips, sonication, light, or other artificial means to achieve a more mature (i.e., aged) product in a shorter time. Using some of those artificial ways to accelerate the aging, however, results in a product that cannot be labeled as bourbon whiskey. For example, some of the artificial means do not use new American oak barrels to age the distillate and, consequently, cannot be labeled as bourbon whiskey as a matter of law. In addition, some of the artificial means to age distillates leave an astringent (bitter) aftertaste, which most consumers dislike.

What is needed, therefore, is a method to accelerate the maturation of whiskey such that it can be called bourbon whiskey and achieves all the benefits of standard aging processes.

### SUMMARY OF THE INVENTION

To these and other ends, a method of accelerating the maturation of distilled spirits is disclosed. The method provides a storage warehouse secured in a waterway that produces waves, with the storage warehouse having an enclosed interior. The method includes storing a plurality of barrels in the enclosed interior of the storage warehouse, the barrels being filled with distilled spirits and moving the storage warehouse and the barrels therein by the waves of the waterway so as to circulate the distilled spirits within the plurality of barrels to thereby accelerate the maturation of the distilled spirits. The method contemplates permanently coupling the storage warehouse to a stationary object so as to secure the storage warehouse at a position within the waterway. In one aspect, stationary object is land and the storage warehouse includes a connecting ramp for coupling the storage warehouse to the land. In another aspect, the storage warehouse is considered a bonded warehouse.

The method may further include providing a base structure and the storage warehouse is placed atop and secured to the base structure. The base structure is buoyant to keep the storage warehouse afloat in the waterway.

In an embodiment, the storage warehouse is sized to accommodate a first array of barrels eight barrels wide and two barrels deep in a first layer and a second array of barrels eight barrels wide and two barrels deep, the second array of barrels placed atop the first array of barrels.

In an embodiment, the method further includes removing the plurality of barrels from the storage warehouse after the maturation of the distilled spirits is essentially complete. The method may also include filling bottles with the matured distilled spirits from the removed plurality of barrels with little or no additional maturation of the matured distilled spirits since the time the plurality of the barrels were removed from the storage warehouse.

The invention also contemplates an aging apparatus for accelerating the maturation of a distilled spirit. The aging apparatus includes a base structure configured to float in a waterway capable of producing waves and a storage warehouse placed atop and secured to the base structure. The storage warehouse has an interior space sized to accommodate a plurality of barrels filled with distilled spirits. When the base structure is subjected to waves, the base structure experiences cyclic motion and the distilled spirits circulate within the plurality of barrels. In one aspect, the storage warehouse is a bonded warehouse.

In an embodiment, the base structure is permanently coupled to a stationary object in the waterway so as to secure the storage warehouse at a position within the waterway. The stationary object may be land.

In yet another embodiment, the aging apparatus further includes an enclosure configured to extend along at least one side of the aging apparatus which is facing the body of water.

Other features of the method and aging apparatus are further disclosed and described below.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a perspective view of a storage warehouse placed atop a base structure according to one embodiment of the invention with a partial cutaway showing stacked oak barrels inside the storage warehouse.

FIG. 2 is a cross-sectional view of the stacked oak barrels filled with whiskey located within the storage warehouse of FIG. 1.

### DETAILED DESCRIPTION OF THE INVENTION

The invention provides an aging apparatus and a method for accelerating the maturation of bourbon whiskey distilled spirit where the final aged product has the characteristics associated with a much longer maturation process. The terms “aged”, “aging”, “matured”, “maturing”, and “maturation” may be used interchangeably herein.

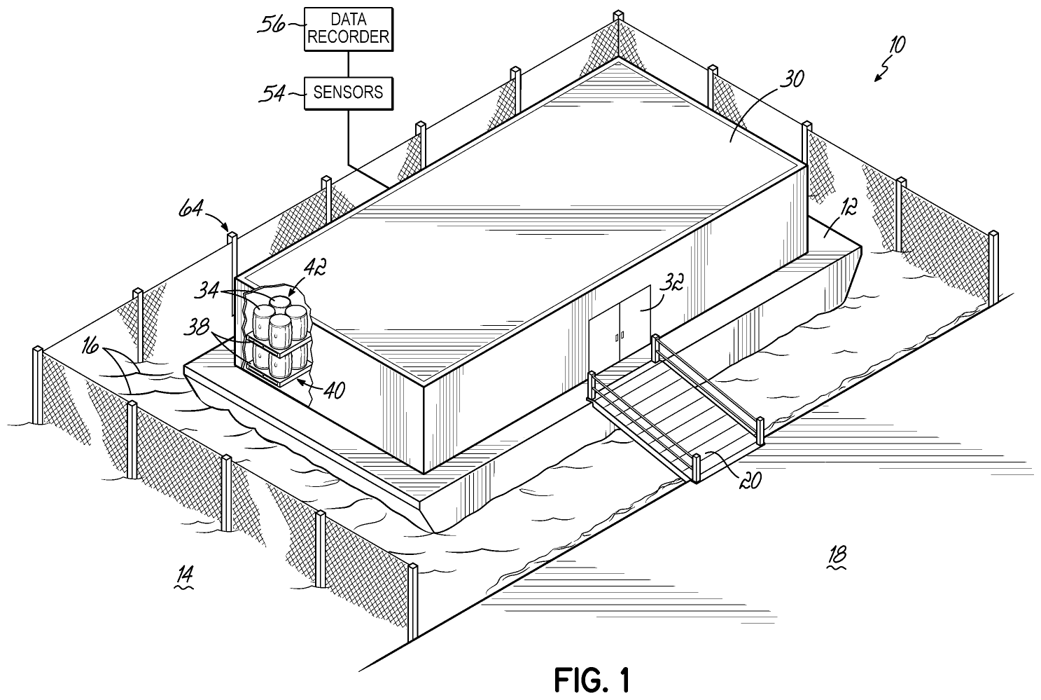

An aging apparatus 10 according to one embodiment of the invention is illustrated in FIG. 1. The aging apparatus includes a base structure 12 that is located on a body of water 14, such as an open waterway, that is capable of producing waves 16. The base structure 12 is configured to float on the open waterway and support any structures placed upon it as will be described. The base structure 12 is secured to a stationary object, such as land 18, via a connecting ramp 20. In an embodiment the base structure 12 is permanently secured to the land 18 such that the aging apparatus cannot leave the land and float into body of water 14 or otherwise be moved away from the land 18 by a flowing current in the body of water 14. In view of the aging apparatus 10 being permanently secured, the aging apparatus 10 may be characterized as an extension of the land 18, but can still move in response to the waves 16. In an embodiment, the connecting ramp 20 is adapted to allow the base structure 12 to move up and down as the level of the body of water 14 rises and falls. The base structure 12 may also be additionally secured to the land 18 via one or more cables or chains.

The aging apparatus 10 is not configured to be a “vessel” as that term may be defined by federal and state statutes and regulations and interpreted by federal and state courts. As such, the aging apparatus 10 is not intended to be a means of transportation on water. To that end, the aging apparatus 10 has no rudder or other steering mechanism, no propulsion source, and no onboard electrical generation or storage. The aging apparatus 10 may be connected by onshore electrical power. The intent is that once the aging apparatus 10 is coupled to the land 18 to age distilled spirits, the aging apparatus 10 will remain there indefinitely. The aging apparatus 10 may be moved from time to time as maintenance requires or if the aging apparatus 10 is decommissioned and taken out of service.

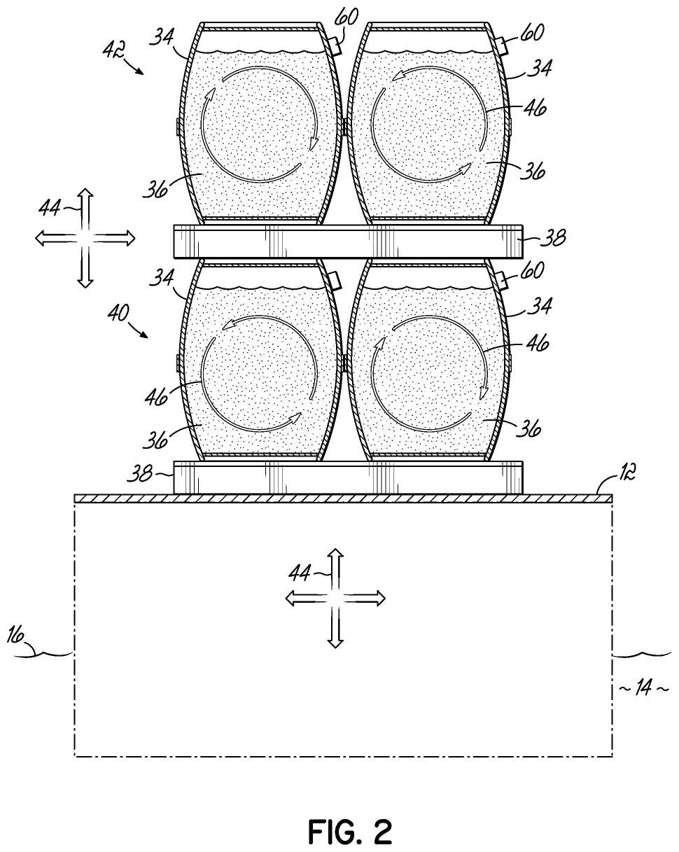

A storage warehouse 30 is located atop and secured to the base structure 12. In an embodiment, the storage warehouse 30 may be structurally configured like a rack house which is often used to store barrels filled with distilled spirits. Such a rack house would include an enclosed interior that is substantially impervious to precipitation and sunlight. The storage warehouse 30 includes a door 32, which allows entry into the interior of the storage warehouse 30. With reference to FIGS. 1 and 2, liquid containers 34, such as barrels, filled with distilled spirits 36, such as whiskey, are placed in the interior of the storage warehouse 30. In an embodiment, the liquid containers 34 are barrels that may be placed atop support platforms 38, such as wood pallets. Preferably the barrels 34 are constructed of oak, which is the traditional wood for barrels used to age whiskey. While the distilled spirits 36 are typically placed into new constructed barrels 34, the distilled spirits 36 may be placed into previously used barrels or even wine casks.

In an embodiment, four barrels 34 are placed on the support platform 38 to form a lower layer 40 and then an upper layer 42 of four barrels 34 on another support platform 38 is stacked atop the lower layer 40. The storage warehouse 30 is then loaded with two rows of lower layers 40 with two rows of upper layers 42 on top. In one configuration, the storage warehouse is sized to accommodate up to 324 support platforms 38 in the lower layers 40 and up to 324 support platforms 38 in the upper layers 42 for a total of 648 support platforms for a total of 2,592 barrels 34. As will be appreciated, the storage warehouse 30 could be of any size to accommodate fewer or more support platforms 38 and thus fewer or more barrels 34.

Preferably, the connecting ramp 20 is sized and strong enough to accommodate a loading device, such as a forklift, to move over the connecting ramp 20 so upper and lower layers 40, 42 may be quickly and efficiently loaded onto or removed from the storage warehouse 30. In that regard, the door 32 should be configured to allow the loading device (forklift) to readily pass therethrough. The door 32 may be of any suitable configuration such as a single door, a double door, an overhead door, and the like.

With reference to FIG. 2, the waves 16 generated by the body of water cause the base structure 12 and thus the storage warehouse 30 to move up and down and perhaps side-to-side as illustrated by arrows 44. The motion of the storage warehouse 30 causes the distilled spirits 36 in the barrels 34 to actively circulate inside the barrels 34 as schematically illustrated by the arrows 46. As discussed below, the active circulation of the distilled spirits 36 in the barrels 34 is an aspect of accelerating the aging of the distilled spirits 36.

The storage warehouse 30 may include one or more sensors 54 to monitor a variety of environmental conditions on either the exterior or interior of the storage warehouse 30 or both. For example, one sensor 54 may be used to measure the temperature on the exterior and/or interior of the storage warehouse 30. Another sensor 54 may be used to measure the relative humidity in the interior of the storage warehouse 30. Another sensor 54, such as an inclinometer, may be used to record the motion of the base structure 12 and the storage warehouse 30 as they move up and down and side to side in response to the waves 16 in the body of water 14. The data collected from the sensors 54 may be recorded so it may be view and analyzed at a later time. To that end, one or more data recorders 56 may be operatively coupled to the sensors 54. For example, a recorder chart or pen recorder may be used to record the temperature and/or relative humidity in the storage warehouse 30 over periods of time, such as weeks, months, and years.

To track inventory in the storage warehouse 30, an inventory control device 60 may be coupled to each barrel 34. In an embodiment, the inventory control device 60 may be an RFID tag that is unique to each barrel it is placed on. For example, the RFID may identify certain characteristics regarding the barrel and the distilled spirits in the barrel, such as the type of wood the barrel is made from, the type of distilled spirits in the barrel, when the distilled spirits was placed in the barrel, which manufacturing facility the distilled spirits came from, what batch or lot number, and the like.

Because the aging apparatus 10 will be permanently secured to the land 18 in an embodiment, the storage warehouse 30 may serve as a bonded warehouse. As a bonded warehouse, the storage warehouse 30 is permitted to store distilled spirits in bond. In addition, the bonded warehouse is locked with access limited to specific personnel. In addition, the land 18 adjacent to the aging apparatus 10 may be secured by fencing, for example, to keep out unauthorized individuals approaching from the land 18. In other words, the bonded warehouse may be considered “secured.” To further assist with securing the aging apparatus from unauthorized entry, the aging apparatus 10 may be surrounding by an enclosure 64, such as a chain link fence, for example. As illustrated in FIG. 1, the enclosure 64 surrounds the aging apparatus 10 along at least three sides of the aging apparatus 10 and the ends of the enclosure 64 being affixed to the land 18, where those three sides of the aging apparatus 10 are facing, i.e., exposed to, the body of water 14. Without the enclosure 64 along those three sides, the aging apparatus 10 may be boarded by an unauthorized individual who comes along any of those sides of the aging apparatus 10 with a boat or other watercraft. In other configurations where the land 18 confronts more than one side of the aging apparatus 10, the enclosure 64 may surround only two sides or only one side of the aging apparatus 10. The enclosure 64 may also extend sufficiently below the waterline of the body of water 14 to prevent an unauthorized individual from readily going underneath the bottom of the enclosure 64.

A bonded warehouse is subject to significant oversight by the Alcohol and Tobacco Tax and Trade Bureau (“TTB”) and is subject to compliance with the Federal Alcohol Administration Act (“FAA Act”), all applicable regulations promulgated by the TTB under the FAA Act, the Internal Revenue Code, as well as any relevant state and local statutes, regulations, and/or ordinances. The strict requirements and criteria of a bonded warehouse ensures that spirits will be able to safely enter the United States marketplace after they have aged. The unmatured spirits will remain in the bonded warehouse until the aging process is complete, being removed only for bottling and packaging as a finished spirit. In other words, the barreled spirits is not partially aged for a short period and then moved to a more traditional rack house to finish the aging process. The spirit is aged essentially entirely while in the bond warehouse before being removed.

The invention also contemplates a method using the aging apparatus 10 discussed above. In an embodiment, the method uses barrels 34 made from newly charred American oak. Moreover, the method does not use any artificial aging agents so that the final aged product may still be accurately labelled as bourbon whiskey.

The method involves placing unmatured distilled spirit 36 in newly charred American Oak wood barrels 34 and placing those filled barrels in the storage warehouse 30 which is atop the base structure 12. The base structure 12 should be on a body of water 14 that is capable of producing waves 16, i.e., wave action. As the storage warehouse 30 is rocked up and down and side-to-side by the active cyclic motion of the waves 16, the distilled spirit 36 circulates around the inside of the barrel 34 as schematically shown by arrows 46 (FIG. 2). As a consequence of this active cyclic motion, more of the distilled spirit 36 contacts with the charred American Oak wood of barrel 34 compared to a barrel that is stationary, i.e., on land with no active cyclic motion. Advantageously, this method for accelerating the maturation bourbon whiskey distilled spirit 36 complies with the TTB labeling requirements. That is, this method of aging allows the aged whiskey to still be accurately labelled as bourbon whiskey.

In an embodiment, the method contemplates keeping the barrels 34 in the storage warehouse 30, where the storage warehouse 30 is classified as a bonded warehouse, for the entire accelerated aging process of the distilled spirits. That is, the barrels 34 remain in the bonded storage warehouse 30 until the aging process is essentially completed and then the barrels 34 are removed from the bonded storage warehouse 30, transported to a bottling facility, and the aged distilled spirits are placed into bottles for consumer distribution. The bottles are filled with the aged distilled spirits, which has been extracted from the barrels removed from the bonded warehouse, with little or no additional aging of the distilled spirits since the time the barrels were removed from the bonded storage warehouse. A bottle of bourbon that has been aged for at least two years may be labeled “Kentucky Straight Bourbon.”

The cyclic motion caused by the waves 16 increases the rate of diffusion of the ethanol and water through the porous structures of the charred American Oak wood. More specifically, capillary action draws the distilled spirit 36 into inner structures where it interacts with the natural absorption of oxygen causing a catalyzed reaction that results in the formation of whiskey lactones, phenolic compounds, aldehydes, esters, and other compounds. While the partial pressure is the primary driving force into the porous structure of the charred American Oak wood, the motion increases the rate of mixing. Static barrels, i.e., those not subject to active cycle motion, require heat variations to create convective mixing of the bulk liquid. Enhanced mixing though active cyclic motion maintains a higher partial pressure in the barrel and thus the reactions that occur in the liquid and at the surface of the wood are increased. The hem icellulose, lignin, oak tannins, and char layer all contribute to the thousands of chemical compounds present in a mature bourbon whiskey. While kinetic models for accelerated aging of distilled spirits are being developed, it is believed that the increased reaction kinetics is the result of 1) the increased rate of collisions of the molecules and 2) the increased partial pressure of the barrel because of the increased chemical reactions occurring. Concentration gradients are sustained, driving the speed of the reactions.

The distilled spirit 36 actively circulated in the charred American Oak barrel 34 accelerates extraction of traditional bourbon whiskey compounds, such as b-d-glucoside of b-Sitosterol, b-Sitosterol, ethyl caprate, ethyl laurate, ethyl myristate, caprylic acid, ethyl palm itate, capric acid, ethyl palm itoleate, ethyl stearate, lauric acid, ethyl oleate, ethyl linoleate, arabinose, glucose, xylose, fructose, Gallic acid, 5-HMF, furfural, vanillic acid, 5-methyl furfural, syringic acid, vanillin, syring-aldehyde, ellagic acid, conifer-aldehyde, sinap-aldehyde. It is estimated that this method may achieve the same finish characteristics as traditionally-aged bourbon whiskey, but in half the time. For example, if a producer normally aged the bourbon whiskey for three years using conventional methods (e.g., in stationary American Oak barrels), the inventive method could achieve the same aged bourbon whiskey in approximately one and half years. Shortening the aging time will also reduce the amount of distilled spirit lost to evaporation, yielding more finished product for the producer to sell to consumers.

The description of the method above brings the unmatured distilled spirits into the storage warehouse 30 in barrels 34 to begin the maturing process. The method also contemplates bring matured distilled spirits that have already been matured in a conventional, land-based, rack warehouse for secondary aging. In that case, the matured distilled spirits would be transferred to a secondary container, such as a barrel or wine cask made from Spanish Oak. Those Spanish Oak barrels or wine casks filled with matured distilled spirits would be placed in the storage warehouse 30 for secondary aging or finishing so that the distilled spirits pick up additional flavonoid components not present during the first aging process. In one variation, distilled spirits aged in the barrels 34 in the storage warehouse 30 may be transferred to a secondary container also in the storage warehouse 30 to provide for secondary aging. In this variation the entire aging process (primary and secondary) of the distilled spirit is conducted solely in the storage warehouse 30.

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method of accelerating the maturation of distilled spirits comprising:
providing a storage warehouse secured in a waterway that produces waves, the storage warehouse having an enclosed interior;
storing a plurality of barrels in the enclosed interior of the storage warehouse, the barrels being filled with distilled spirits; and
moving the storage warehouse and the barrels therein by the waves of the waterway so as to circulate the distilled spirits within the plurality of barrels to thereby accelerate the maturation of the distilled spirits.

2. The method of claim 1 wherein the plurality of barrels forms a first layer of barrels and a second layer of barrels, with the second layer of barrels placed atop the first layer of barrels.

3. The method of claim 2 wherein the first layer of barrels is placed onto a first support platform and the second layer of barrels is placed onto a second support platform, the second support platform being placed atop the first layer of barrels.

4. The method of claim 1 further comprising:
permanently coupling the storage warehouse to a stationary object so as to secure the storage warehouse at a position within the waterway.

5. The method of claim 4 wherein the stationary object is land and the storage warehouse includes a connecting ramp for coupling the storage warehouse to the land.

6. The method of claim 1 further comprising:
providing a base structure, the storage warehouse placed atop and secured to the base structure, the base structure being buoyant to keep the storage warehouse afloat in the waterway.

7. The method of claim 1 wherein the storage warehouse is sized to accommodate a first array of barrels eight barrels wide and two barrels deep in a first layer and a second array of barrels eight barrels wide and two barrels deep, the second array of barrels placed atop the first array of barrels.

8. The method of claim 1 further comprising:
monitoring one or more environmental conditions in or around the storage warehouse.

9. The method of claim 8 further comprising:
recording the monitored one or more environmental conditions.

10. The method of claim 1 wherein the storage warehouse is a bonded warehouse.

11. The method of claim 1 further comprising:
removing the plurality of barrels from the storage warehouse after the maturation of the distilled spirits is essentially complete.

12. The method of claim 11 further comprising:
filling bottles with the matured distilled spirits from the removed plurality of barrels with little or no additional maturation of the matured distilled spirits after the plurality of the barrels are removed from the storage warehouse.

13. An aging apparatus for accelerating the maturation of a distilled spirit comprising:
a base structure configured to float in a waterway capable of producing waves; and
a storage warehouse placed atop and secured to the base structure, the storage warehouse having an interior space sized to accommodate a plurality of barrels filled with distilled spirits, and
wherein when the base structure is subjected to waves, the base structure experiences cyclic motion and the distilled spirits circulate within the plurality of barrels.

14. The aging apparatus of claim 13, wherein the storage warehouse is sized to house a first layer of barrels and a second layer of barrels, with the second layer of barrels placed atop the first layer of barrels.

15. The aging apparatus of claim 14, wherein the first layer of barrels is placed onto a first support platform and the second layer of barrels is placed onto a second support platform, the second support platform placed atop the first layer of barrels.

16. The aging apparatus of claim 13 further comprising a connecting ramp operatively coupled to the base structure, the connecting ramp adapted to couple the base structure to a stationary object so as to secure the base structure in the waterway and allow the base structure to experience cyclic motion.

17. The aging apparatus of claim 13 further comprising:
one or more sensors to monitor environmental conditions in or around the storage warehouse; and
a data recorder configured to record the environmental conditions monitored by the one or more sensors.

18. The aging apparatus of claim 13 wherein the storage warehouse is a bonded warehouse.

19. The aging apparatus of claim 13 wherein the base structure is permanently coupled to a stationary object in the waterway so as to secure the storage warehouse at a position within the waterway.

20. The aging apparatus of claim 19 wherein the stationary object is land.

21. The aging apparatus of claim 13 further comprising:
an enclosure configured to extend along at least one side of the aging apparatus that faces the waterway, wherein the enclosure is configured to prevent entry to the aging apparatus along that at least one side of the aging apparatus.
